(19) United States
(12) Patent Application Publication
(10) Pub. No.: US 2014/0079486 A1
(43) Pub. Date: Mar. 20, 2014

(54) BLOCKING DEVICE

(71) Applicants: Franco Argelli, Ravenna (IT); Renzo Righini, Ravenna (IT)

(72) Inventors: Franco Argelli, Ravenna (IT); Renzo Righini, Ravenna (IT)

(73) Assignee: F.lli Righini S. R. L., Ravenna (IT)

(21) Appl. No.: 14/116,062

(22) PCT Filed: May 8, 2012
(86) PCT No.: PCT/IT2012/000134

§ 371 Date: Nov. 6, 2013

(30) Foreign Application Priority Data
May 9, 2011 (IT) RA2011A000018

(51) Int. Cl. F16L 1/23

(52) U.S. Cl. CPC F16L 1/23
USPC 405/158

(57) ABSTRACT

Blocking device (1) to hold integrally an elongated body (EB) relative to an external reference (A); the blocking device (1) comprising a module (2) provided with a first, a second, and a third holding members (10) (20) (30) of substantially identical longitudinal extension, arranged in a substantially concentric manner relative to a central axis (Z1); each module comprising connecting means (40) designed to couple the first, second, and third holding members (10) (20) (30); a clamping unit (50) being associated with at least two of the first, second, and third holding members (10) (20) (30) to move them, in use, relative to one another in order longitudinally to stop, in use, the elongated body (EB); the first, second, and third holding members (10) (20) (30) being connected in a hinged manner two by two so that they can pivot relative to the central axis (Z1).

### CROSS REFERENCE TO RELATED APPLICATIONS

This application is a national phase of PCT application No. PCT/IT2012/000134, filed May 8, 2012, which claims priority to IT patent application No. RA2011A000018, filed May 9, 2011, all of which are incorporated herein by reference.

The present invention relates to a pad for transversally holding an umbilical so as to stop it relative to an external reference. In particular, the present invention relates to a blocking device to hold integrally the umbilical relative to the external reference through the use of this pad.

### BACKGROUND TO THE INVENTION

In the field of the constructions requiring the installation of elongated members, among which umbilicals (long tubular bodies usually covered with medium-density polyethylene which contain, for example, cables for transmitting electric, electronic signals, hydraulic hoses, refrigerating conduits and often present different cross sections at different heights) and metal tubes for the construction of pipes for above- and under-ground or subsea transportation of fluid and/or information, it may be useful to put these bodies inside trenches or on the seabed holding them through friction transversally to their central axis. In the tubes this axis coincides with a respective longitudinal geometrical axis whereas in the umbilicals this axis can be off-centre and differ from this geometrical axis according to the actual arrangement of the electrical wires or of the respective refrigerating conduits or of fluid transport pipes. It should be specified that each elongated body presents a given length and is designed to joined through welding or other technology so as to cover lengths definable at will; furthermore, with each elongated member a range of allowable transverse pressures is associated, above which this member can be damaged, thus jeopardizing all the transmission and transport line to which it belongs. As regards umbilicals, very long distances must often be covered, and it is therefore necessary to reel the single cables in up to several kilometres. Masses in the order of some thousands of tonnes can be therefore associated with each reel, and the cable can present rigidity during unwinding and different arrangements of the inner components according to the bend radius of the segment being unwound. It is clearly apparent that this kind of products, with which loads like these can be associated, shall be handled carefully to avoid their damage during the unwinding and installation steps. On the other hand, when these cables are laid from a vessel, it could be useful to have available devices designed to stop the laying step to join these cables or maintain the laying devices. In particular, the point p. of the section 15.2 “Requirements for installation vessel and equipment” of the standard ISO 1362S-5:2009 states that the vessel equipment requirements shall include “device to cut the umbilical, and holding clamps, in case of emergency”; at the end of the section the following is also stated: “The installer shall carry back-up equipment on-board the vessel whenever this is practicable, and shall ensure that at all time suitable spares are available for rapid repair of all essential items”.

There are therefore many reasons for having on-board a holding device or “clamp”, allowing to manage the cable to allow the laying device to be repaired or maintained.

The devices currently used for blocking an elongated member during installation provide for the use of a metal sheath allowing to wind the outer shell of the umbilical which tightens and elongates on the shell producing a membrane force whose resultant allows to annul the longitudinal tension acting on the wire, and thus to stop the laying thereof, allowing to free the laying device onto which it will be possible freely to act. The use of this equipment does not allow an adequate adjustment of the compression force; the shear stress induced in the elongated member could therefore exceed the allowable shear range and damage the member. For this reason, this device is usually used for medium-low loads, as for high loads high lengths would be necessary, that could complicate the management thereof Obviously, this feature limits the field of use of the above described equipment.

To improve the shear distribution to block the segment to be laid of an elongated member, a device has been used provided with a plurality of fixed sectors, fastened two by two through an equal number of screw connections uniformly distributed along the length of the saddles and arranged tangentially to the outside of cross sections of adjacent saddles. Each connection can be adjusted at will by acting on a nut; it is however easily understood that, above all for umbilicals, this system is unreliable poorly effective, also because, due to above illustrated reasons, an umbilical may present different cross sections at different heights. The described device usually comprises at least one eyebolt coupled to at least one of the saddles in end position to connect the device with a mast or with the vessel fixed equipment. In the case of three saddles with angular extension of nearly 120° and longitudinal extension in the order of one meter, necessary to distribute the pressure on sufficiently long segments, so as to avoid the local collapse of the elongated member, the number of the screw-couplings could be high, comprised between 36 and 45. Obviously, tightening such a high number of threaded connections that must be adjusted manually requires a very long time, and the described device is therefore not suitable for the emergency cases for which it has been designed, as usually during these situations the operators nervousness and agitation complicate the operations and may affect the result. Obviously, the blocking times are even longer if you desire to control the blocking tension of the threaded connections using torque wrenches.

Examples of equipments employed for making up threaded joints on tubular goods (tubing and casing) used for well drilling are well described in patents U.S. Pat. No. 4,869,137, EP 1452685, WO 94/05894, but they do not represent pertinent prior art for evaluating the patentability of the present invention, which is focused on a device for transversally holding an umbilical. Therefore, for the sake of simplicity, these documents are not discussed in the following.

In view of the above description, the problem of having available a blocking device for blocking an umbilical usable to construct a ground or subsea transport line for a fluid (oil, gas, etc.) or a mixed line for the exchange of information and fluid, is currently solved in an unsatisfactory manner and represents an interesting challenge for the Applicant, in order to facilitate maintenance operations of the equipment for laying and joining umbilicals through the permanent connection of respective end portions.

In view of the situation described above, it would be desirable to have available a blocking device which, in addition to enabling to limit and possibly to overcome the typical drawbacks of the art illustrated above, could define a new standard for these types of equipment.

### SUMMARY OF THE PRESENT INVENTION

The present invention relates to a pad for transversally holding an umbilical so as to stop it relative to an external reference. In particular, the present invention relates to a blocking device integrally to hold the umbilical relative to the external reference through the use of this pad.

An object of the present invention is to provide a blocking device which allows the disadvantages described above to be solved, and which is suitable to satisfy a plurality of requirements that to date have still not been addressed, and therefore suitable to represent a new and original source of economic interest, capable of modifying the current methods for laying umbilical, of simplifying these operations and the maintenance of the equipment used therewith, making them faster and cheaper.

According to the present invention, a blocking device is provided, whose main characteristics will be described in at least one of the appended claims.

A further object of the present invention is to provide a pad for a blocking device usable for laying umbilical as illustrated above.

According to the present invention a pad is furthermore provided for a blocking device usable for laying umbilical as described above, the main characteristics of this pad being described in at least one of the appended claims.

A further object of the present invention is to indicate a use of a given material for producing a pad as described above.

According to the present invention a use of a given material is furthermore indicated for producing a pad as described above, the main characteristics of this use being described in at least one of the appended claims.

### BRIEF DESCRIPTION OF DRAWINGS

Further characteristics and advantages of the blocking device, of the pad for this device and of the use of a given material for producing this pad according to the present invention will be more apparent from the description below, set forth with reference to the accompanying drawing, which illustrate some non-limiting examples of embodiment, in which identical or corresponding parts of the device are identified by the same reference numbers. In particular:

FIG. 1 shows a schematic perspective view of a blocking device according to the present invention;

FIG. 2 is an axial view of FIG. 2 in a first operating position

FIG. 3 is an axial view of FIG. 2 in a second operating position

FIG. 4 is a cross sectional view of FIG. 1;

FIG. 5 is a schematic perspective view in enlarged scale and with some parts removed for the sake of clarity of a detail extracted from FIG. 4;

FIG. 6 is a view in enlarged scale and with some parts removed for the sake of clarity of a detail extracted from FIG. 4 and of a respective detail cut at the top and in more enlarged scale;

FIG. 7 is a plane view of FIG. 1; and

FIG. 8 is a simplified section of the variants of a detail extracted from FIG. 6;

FIG. 9 shows a section of at least one variant of FIG. 5.

### DETAILED DESCRIPTION OF THE PRESENT INVENTION

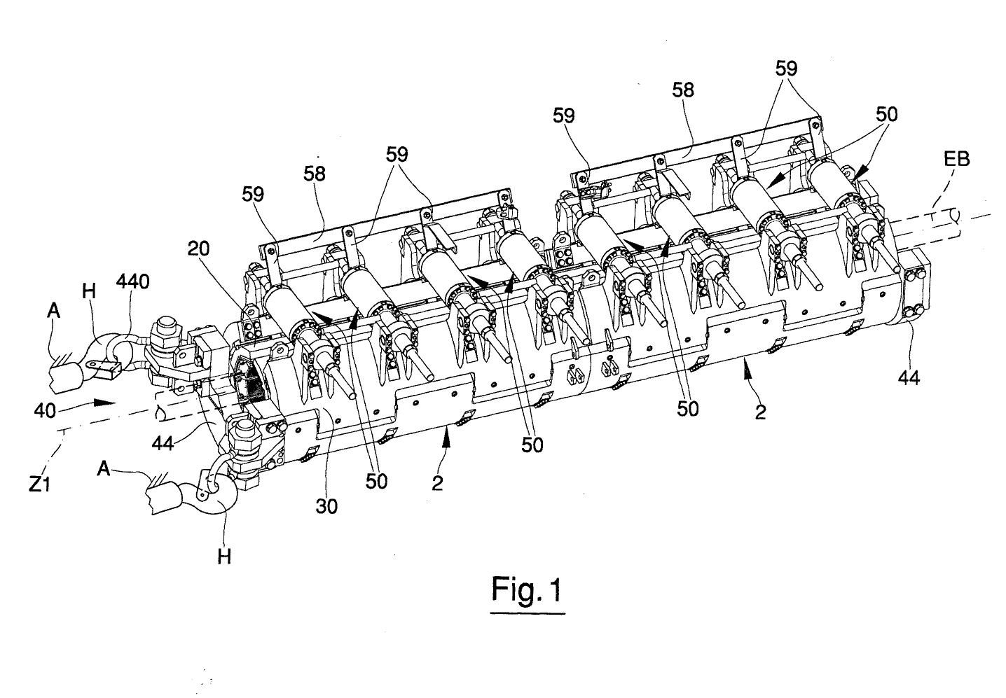

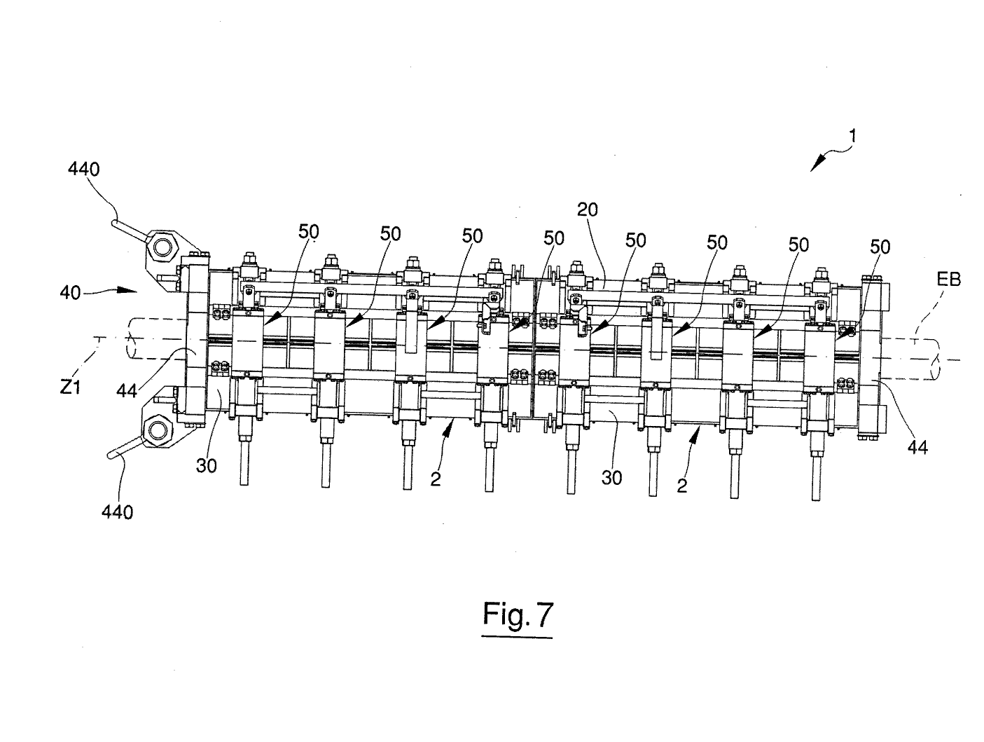

In FIG. 1 number 1 indicates, in its entirety, a blocking device usable integrally to hold an elongated body EB (shown in FIGS. 1 and 7, where it is represented in dotted lines) relative to a fixed external reference A, with which the device 1 is connected rigidly, this elongated body EB being designed to be used to construct a ground or subsea transportation line, known and therefore not shown, for a fluid (oil, gas, etc) or for contemporaneous exchange of information and fluid.

The external reference A is shown only in FIG. 1, where it is schematically illustrated with a conventional symbol comprising three parallel segments, and supports a pair of hooks H that will be described herein.

The elongated body EB is preferably an umbilical, a substantially cylindrical member designed for the construction of pipes for above- and under-ground or subsea transportation of fluid and/or information usually covered with medium-/high-density polyethylene. However, even though the blocking device 1 is designed to clamp umbilicals, it might be used indifferently to hold a cylindrical tube made of metal or plastic. In both cases, to each kind of elongated body EB is associated a range of allowable transverse pressures that shall not be exceeded to maintain respective structural integrity and correct operation. For the sake of clarity, in the following the expressions “umbilical” and “elongated body” will be used indifferently except in the cases in which it will be clear that the expression “elongated body” refers to tubing.

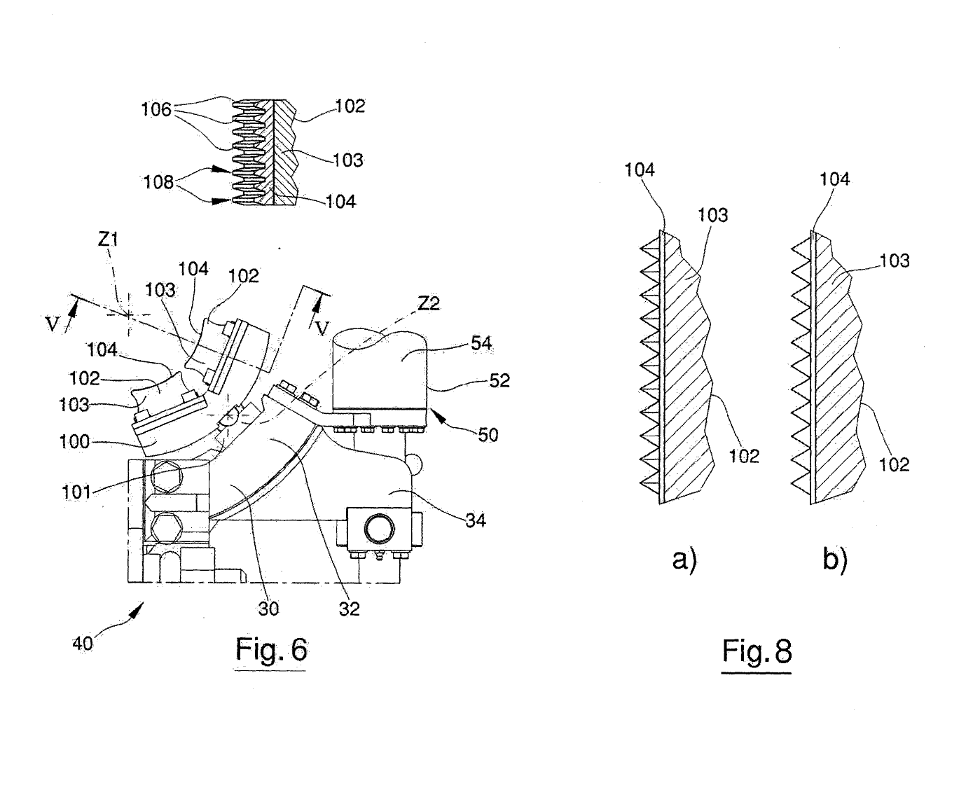

With particular reference to FIGS. 1 and 6, the device 1 comprises at least one module 2 provided with a first, with a second and with a third holding members, indicated respectively with the reference numbers 10, 20, and 30 and better shown in FIG. 4. These holding members present substantially identical longitudinal extension and are arranged in a substantially concentric manner relative to a central axis Z1 of the module 2; each module 2 comprises a connecting group 40 to couple the first, second and third holding members 10, 20, 30 to one another. Each module 2 comprises clamping members 50 associated with at least two of the first, second and third holding members 10, 20, 30 to move them, in use, so that they can pivot relative to one another with reference to the central axis Z1. In view of the above description, the first, second and third holding members 10, 20, 30 allow longitudinally to stop, in use, the umbilical EB, as it will be better explained below.

With particular reference to FIG. 4, the first holding member 10 is shaped like a prism with C-shaped cross section and presents a longitudinal central portion 12 delimited, on both the sides parallel to the central axis Z1, by longitudinal symmetric and substantially identical wings 14. Moreover, said second holding members 20 and third holding members 30 are arranged symmetrically relative to the longitudinal central portion 12 and shaped similarly to each other; the connecting group 40 comprises a first rod 42 parallel to the central axis Z1 and suitable to pivot the second holding member 20 to the first holding member 10. The connecting group 40 furthermore comprises a second rod 43 parallel to the first rod 42 and suitable to pivot the third holding member 30 to the first holding member 10.

In view of the above description, the first holding member 10 is arranged between the second and third holding members 20, 30 so as to act as a frame for each of them. This allows to connect the first, second and third holding members 10, 20, 30 in a hinged manner two by two so that they can pivot relative to one another and to the first member 10 with reference to the axis Z1. The second and third holding members 20 and 30 respectively present a free second end portion 22 and a free third end portion 32.

The clamping members 50 comprise at least one linear actuator 52, arranged transversally to the central axis Z1 between the second and third end portions 22 and 32 to adjust an angular position of the respective second and third holding members 20 and 30 relative to the first holding member 10. As the extension of each module 2 is usually not shorter than one meter, it could be useful to provide the device 1 with a plurality of linear actuators 52, distributed longitudinally in a stepped manner along the length of the single module 2. In the description below reference will be made to this situation, illustrated in FIGS. 1 to 6, without however limiting the general scope of the invention.

Each linear actuator 52 presents a casing 54 that longitudinally houses a stem 56. Each end portion 32 presents a first coupling member 34, designed to support the respective casing 54 through the interposition of a hinge 35, whose pivot axis is parallel to the central axis Z1, so as to allow free adjustments of the position of the axis of the stem 56 relative to the central axis Z1. Each stem 56 is longitudinally delimited by a second coupling member 560, substantially parallel to the central axis Z1, and presents a head 562, substantially cylindrical and parallel to the central axis Z1. Each second end portion 22 presents, for each stem 56, a substantially concave coupling portion 24 designed to house a respective head 562 in a perfectly matching manner. In view of the above description, the combination of the hinge 35 and the coupling portion 24 ensures that, in use, the stem 56 is subjected only to axial stress and is therefore usable to adjust finely a distance between the free first end portion 22 and the free second end portion 32. This allows to obtain a concentric holding pressure of entity which can be defined at will through the first, second and third holding members 10, 20, and 30. If the stem 56 is screw-coupled to the casing 54 so that it can be arranged in a longitudinally adjustable manner relative to this casing, the head 562 shall be carried pivoting around a respective longitudinal axis by the stem 56.

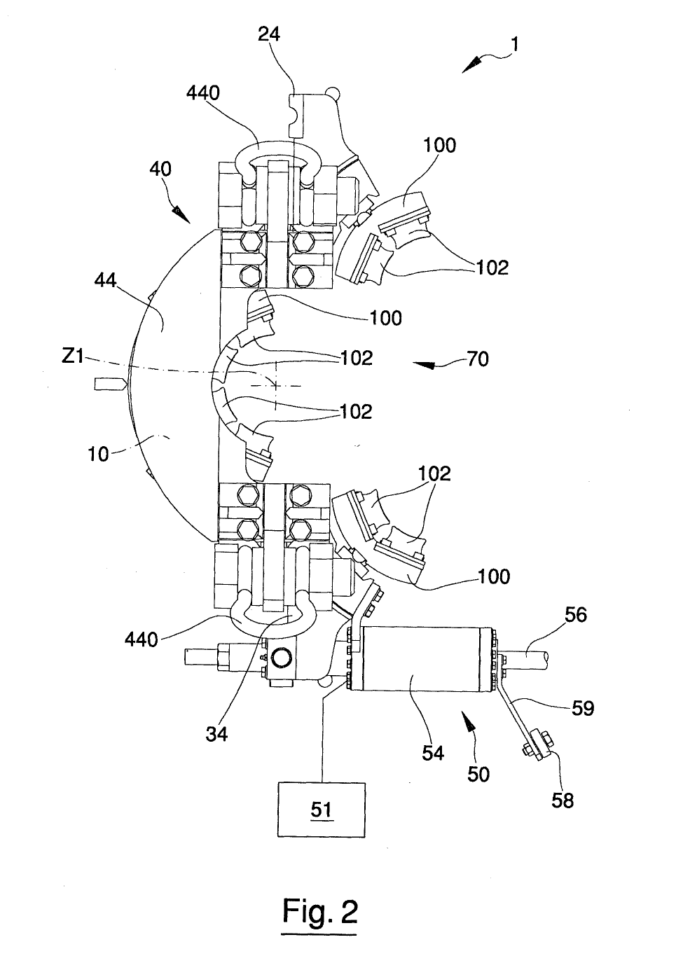

If the linear actuator 52 is of the fluid-dynamic type, the stem 56 is coupled sliding to the casing 54 so that it can be arranged in a longitudinally finely adjustable manner relative to the casing. In this case the coupling of the head 562 and the stem 56 can be rigid. In some cases, to ensure that each linear actuator 52 maintains the hold also in case of hydraulic pressure unexpected loss, a stem 56 could be useful, provided with a threaded rear end at the side of said third end portion 32, so that a safety nut 57 can be used, numbered only in FIG. 4 for the sake of practicality. This nut 57 is designed to fix the longitudinal position of the stem 56 relative to the casing 54, and therefore selectively to stop the opening of the blocking device 1, preventing the third axial end portion 32 from moving away from the second end portion 22, thus avoiding the loosening of the hold on the umbilical EB. With reference to FIGS. 2 to 4, it should be noted that a rod 58 can be associated with each casing 54 through the interposition of a bracket 59, allowing to associate a plurality of actuators 52 with one another, so as integrally to couple them in a pivoting manner and to minimise the number of operations to be performed for equipping the blocking device 1, thus making this operation faster.

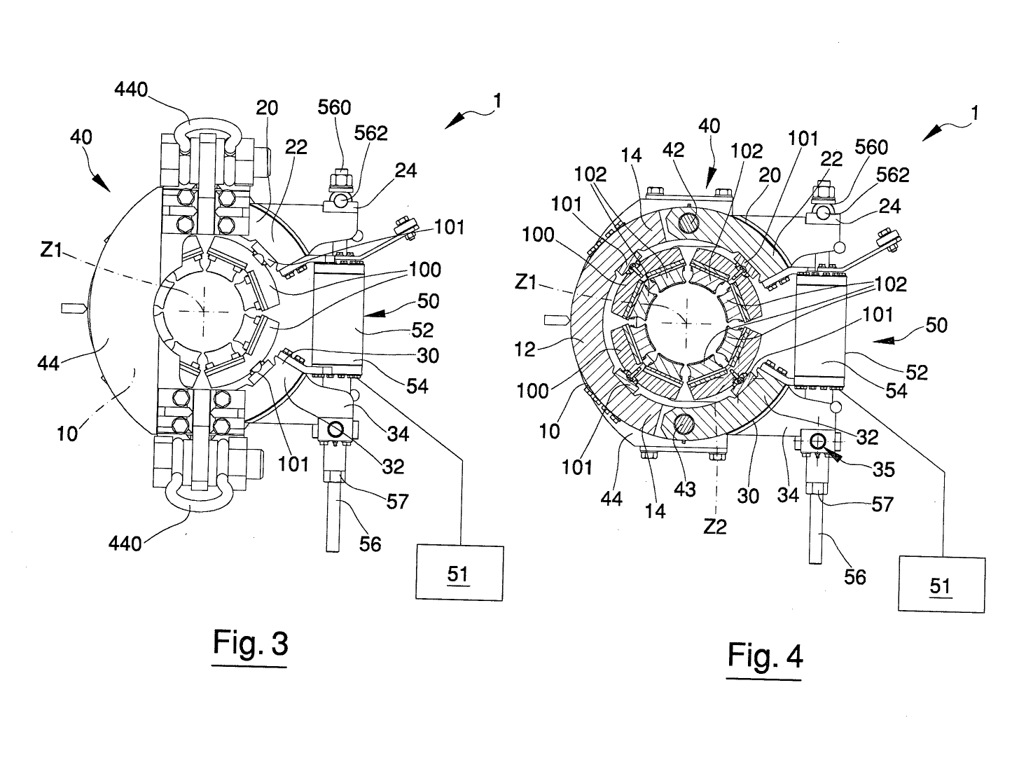

The clamping members 50 can be sensorized constantly to control the position of the stem 56 relative to the casing 54, and therefore the tension locally induced in the umbilical EB, so as to allow the fine adjustment thereof Applying this teaching is particularly effective in the case of fluid-dynamic actuators 52. To this end, the device 1 can comprise a control unit 51 connected with each linear actuator 52, schematized in the only FIG. 3 to simplify the drawing. Through the control unit 51 it is possible, in use, simultaneously to tighten all the linear actuators 52 and to apply a force of longitudinally finely adjustable entity to the umbilical EB and univocally to set the axes of the forces applied to this latter.

In view of the above description it is clearly apparent that the blocking device 1 presents an entrance station 70 (shown only in FIG. 2) that is arranged between the second and third end portions 22 and 32 and extends longitudinally so that the blocking device 1 is completely accessible transversely to the axis Z1. This allows the blocking device 1 to surround the elongated body EB laterally/transversally to the central axis Z1 relative to the fixed external reference A when needed, thus making the blocking operation very simple and fast, that is very important especially in an emergency.

The connecting group 40 comprises a pair of end blocks 44 longitudinally delimiting the first and second rods 42 and 43 to refer longitudinally the first, second, and third holding members 10, 20, and 30 with one another. At least one end block 44 is provided with at least one corresponding support member 440 designed to be coupled with the hooks H carried by the fixed external reference A. In the attached figures, for the sake of practicality each support member 440 is embodied by an eyebolt connected with the respective end block 44 in a sufficiently known and therefore not further explained manner, that is out of the protective scope of the present invention.

With reference to FIGS. 1 and 6, it is clearly apparent that the number of the liner actuators 52 is very limited, and that the device 1 comprises a plurality of modules 2 longitudinally arranged in series and in a close manner between the end blocks 44 through the rods 42 and 43, so as to cover a longitudinal extension of the umbilical EB definable at will.

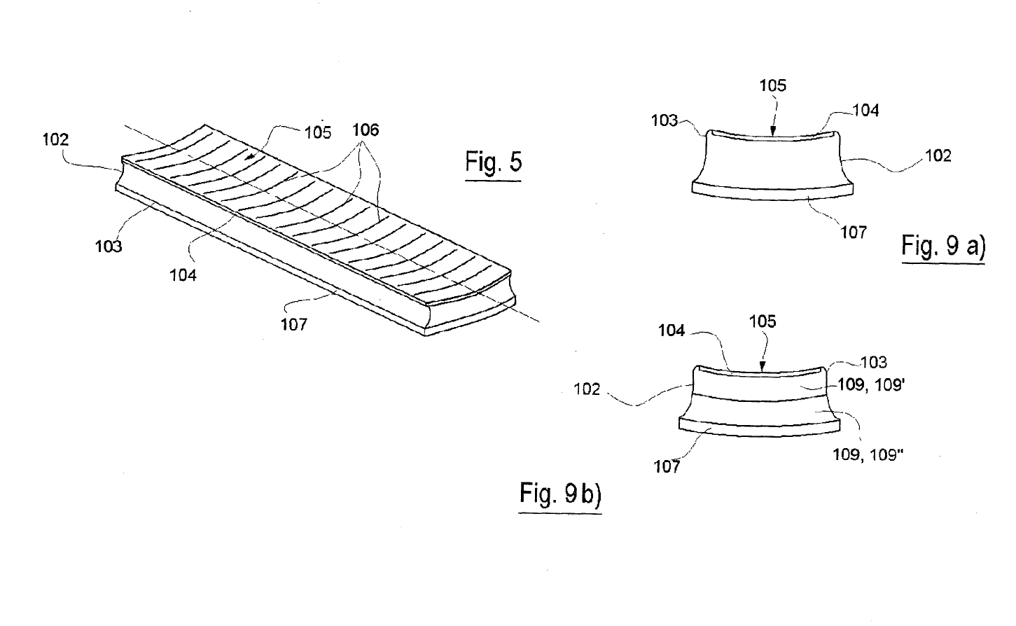

With reference to FIGS. 2 to 6, each of the first, second and third holding member 10, 20, and 30 carries at least one movable equipment 100 pivoting around an axis Z2 (shown only in FIG. 6) parallel to the central axis Z1 through the interposition of a fixed support 101. Each movable equipment 100 can be therefore interpreted as a saddle swinging around an axis parallel to the central axis Z1. Each support 101 is connected to the second/third end portion 22/32 in a known and therefore not illustrated manner, and presents radial extension definable at will, so as to adapt the device 1 to umbilicals EB with given cross section. With particular reference to FIG. 6, each movable equipment 100 carries inside, at the side of the central axis Z1, at least one retaining member 102, simply indicated below with the term “pad”, that can be removable as shown in FIGS. 2 to 4, and present different conformation so as to surround umbilicals EB of different shape/diameter, as it is clearly apparent by comparing the same FIGS. 2 to 4. Moreover, with particular reference to FIG. 5, each pad 102 comprises a base body 103, shaped as a layer of defined and made of a material that can be transversally and longitudinally deformed in the allowable pressure range for the blocking device 1, such as, although without limitation, polyurethane. To the base body 103 a substantially cylindrical shell 104 of given angular width is applied, which is delimited by a face 105 and whose curvature is defined so that it is able to shape-couple with the outer surface of the umbilical EB. The pad 102 presents, at opposite side from the shell 104, a base 107 allowing the pad 102 to be connected to the respective movable equipment 100, for instance, although without limitation, through at least one threaded connection. The shell 104 can be applied to the respective base body 103 in an adhesive manner or in any other suitable manner for connecting the two bodies in a stable and matching manner. Thanks to the deformable nature of the polyurethane, of which the base body 103 has been made, the shell 104 can adapt its shape to the local transverse conformation of the umbilical EB to be held stably through the radial pressure thrust, maintaining the reference relative to the blocking device 1. This allows to meet the different needs of the customers, who may have the need to use the device 1 to hold umbilicals designed for special purposes and covered by a given material.

With reference to FIG. 5 again, the shell 104 presents a plurality of radial reliefs 106, arranged parallel to one another and uniformly distributed longitudinally, each of which can be delimited by a substantially cylindrical crest 108, shown in FIG. 6. However, at least one relief 104 of the shell 104 can be shaped similarly to a pyramid or cone or a transverse cylindrical segment, according to the clients needs, as it is shown in FIG. 8, which illustrates the radial section of a portion of the shell 104 in a simplified form. In view of the above description it should be noted that, in use, during the blocking step, the reliefs 106 of each shell 104 tend to bite the outer shell of the elongated body EB, exerting a mechanical action that can be substantially interpreted as a cutting action.

Each shell 104 can be manufactured in plastic material that can be deformed within a given pressure range or, if deemed useful, in AISI 316, as the device 1 is often used in subsea environment. In particular, the choice of manufacturing the shell 104 in plastic gives the shell 104 a greater capability to adapt to the shape of the facing portion of the umbilical EB. However, if the shell 104 is manufactured in plastic, its hardness shall be greater than that of the covering of the umbilical EB, with which, in use, the shell 104 interacts. If the elongated body EB to be longitudinally released is an umbilical, the respective covering/shell 104 usually presents and hardness of nearly 50 Sh-d and the maximum value of the allowable contact pressure range is equal to or greater than 150 kg/cm². It should be noted that for some hoses the allowable pressure ranges are in the order of 300 kg/cm² but, in this cases, the functionality of the umbilical EB is jeopardized. Therefore, in order to be used in combination with elongated bodies EB of different nature and characteristics and in the off-shore field for pipe laying, each shell 104 shall be conveniently produced in plastic material with a hardness equal to or greater than that of materials like polyethylene, polypropylene and the like, generally used to cover umbilicals, i.e. with hardness greater than 70 Sh-D.

The use of the blocking device 1 illustrated above is clearly apparent from the description above and requires no further explanations. However, it should be specified that the use of movable equipment 100, designed angularly to move similarly to rocker arms, allows the device 1 longitudinally to adapt to the disposition of the umbilical EB to be blocked, in a particularly effective manner when this elongated body is unwound from a reel. The peripheral distribution of the pads 102 allows the tension to be distributed on the outer surface of the umbilical EB, thus maximising the extension of the contact surface and directing the contact pressures in a substantially radial manner. Furthermore, the use of linear actuators allows gradually and simultaneously to tighten the umbilical within the range of given allowable pressures maintained with the necessary continuity, and allows to support the umbilical EB for the necessary time.

It should be furthermore specified that the choice of using polyurethane for manufacturing the base body 103 is linked to the known mechanical characteristics of this material, which can be deformed through compression, showing a flattening, in this case a radial flattening better to allow the respective shell 104 to surround the umbilical EB, and an elongation to follow longitudinal movements of the umbilical EB continuing to hold it relative to the external reference A. This allows locally to distribute the longitudinal load exerted by the blocking device 1 on the umbilical EB in the segments corresponding to each linear actuator 52. The blocking device 1 is therefore suitable stably to hold the umbilical EB, applying to it a substantially uniform load without longitudinal stress concentrations and thus without the corresponding deformations, that could damage it irreparably, making it unusable in the particular field of use.

This solution becomes particularly effective when the blocking device 1 is very extended longitudinally and presents many rows of pads 102 (often more than 8). In this case the vertical load exerted by the umbilical EB on the blocking device 1 is always and continuously shared among all the shells 104 that clamp the umbilical EB in different locations through the base bodies 103.

Lastly, it is apparent that modifications and variants can be made to the blocking device 1 described and illustrated herein, without however departing from the protective scope of the present invention.

For instance, with reference to FIG. 9a, the shell 104 can be integrally coupled to the base body 103 leaving only the face 105 exposed to the umbilical EB to allow, in use, a better support of the shell 104 by the polyurethane of the base body 103 during the blocking operations of the umbilical EB and to allow therefore to maximise the stability of the reciprocal coupling. With reference to FIG. 9b, a possible construction method is illustrated for the base body 103, which can be constituted by more than one polyurethane layer, with the layer 109′ housing the shell 104 with a more rigid mechanical characteristic than the layer 109″ below, and so on for a number of layers greater than two.

In view of the above description, the device 1 and in particular the corresponding pads 102 allow to solve the problem of blocking an umbilical usable to construct a ground or subsea transport line for a fluid (oil, gas, etc.) or a mixed line for the exchange of information and fluid, through holding of a respective segment, this holding is such as contemporaneously to ensure a stable hold of umbilicals and the respect for the corresponding mechanical and functional characteristics. The device 1 and the corresponding pads 102 allow therefore to define a new standard in the sector of holding umbilicals and elongated bodies of different nature.

1-10. (canceled)

11. A pad (102) which can be applied to a movable equipment (100) of a blocking device (1) for transversally holding an umbilical (EB) so as to stop the longitudinal sliding thereof relative to an external reference (A); said pad (102) comprising a shell (104) of given angular width designed to shape-couple with said umbilical (EB), and a base body (103) deformable, in use, to support said shell (104) so as to allow the respective said shell (104) to surround said umbilical (EB) and/or to follow longitudinal movements of said umbilical (EB) continuing to hold it relative to said external reference (A).

12. A pad according to claim 11, wherein said base body (103) comprises a layer of a material capable, in use, of being deformed according to the load acting instantly on the corresponding said shell (104) to allow said shell (104) to adapt its shape to the local transverse conformation of said umbilical (EB).

13. A pad according to claim 12, wherein said layer is made of polyurethane.

14. A pad according to claim 11, wherein said shell (104) presents a face (105) provided with a plurality of reliefs (106) of given shape.

15. A pad according to claim 14, wherein said shell (104) is coupled to said base body in a stable and matching manner.

16. A pad according to claim 14, wherein said reliefs (106) are arranged parallel to one another and uniformly distributed longitudinally, each of them being delimited by a circular crest (108).

17. A pad according to claim 14, wherein at least one respective said relief (106) is shaped similarly to pyramid or cone or a transverse cylindrical segment.

18. A pad according to claim 11, wherein said shell (104) is made of metallic material or plastic material presenting hardness greater than 70 Sh-d so as to be suitable for the holding of tubes covered with polyethylene or polypropylene.

19. A pad according to claim 11, wherein said shell (104) is integrally coupled to said base body (103) so as to present on the outside only said face (105) provided with said reliefs (106).

20. A pad according to claim 11, wherein said base body (103) presents a plurality of layers (109) of different stiffness.
